(19) United States
(12) Patent Application Publication
(10) Pub. No.: US 2013/0046622 A1
(43) Pub. Date: Feb. 21, 2013

(54) METHODS AND SYSTEMS FOR MANAGING A GROUP BUYING PROGRAM

(71) Applicant: Joshua Ray Jennings, Effingham, IL (US)

(72) Inventor: Joshua Ray Jennings, Effingham, IL (US)

(21) Appl. No.: 13/210,871

(22) Filed: Aug. 16, 2011

(51) Int. Cl. G06Q 30/00

(52) U.S. Cl. 705/14.53; 705/14.66; 705/14.58

(57) ABSTRACT

Customer information associated with a plurality of customers and a plurality of offers associated with a plurality of merchants are received from a deal source. At least one offer is selected for presentation to at least one customer based on the customer information.

### BACKGROUND

The present disclosure relates generally to electronic commerce and, more particularly, to methods and systems for managing a group buying program.

At least some known group buying programs include a “tipping point,” wherein a predetermined number of people must elect to participate in a group buying opportunity before the group buying opportunity becomes available. More specifically, in such programs, if a predetermined number of people do not participate in the group buying opportunity, then the group buying opportunity is not made available to anyone in the group. As such, use of the tipping point facilitates limiting a market of potential customers.

To publicize the group buying opportunity, at least some known group buying programs periodically collect contact information from willing participants, and subsequently offer the group buying opportunity to the participants, generally via electronic mail (“email”). Moreover, at least some known group buying programs post group buying opportunities on their website. As such, awareness of group buying opportunities may be limited to the group buying program's willing participants. Furthermore, the successfulness of the group buying program may be limited by the number of willing participants.

### BRIEF DESCRIPTION

In one aspect, a method is provided for managing a group buying program. The method includes receiving, from a deal source, customer information associated with a plurality of customers and a plurality of offers associated with a plurality of merchants. At least one offer is selected for presentation to at least one customer based on the customer information.

In another aspect, a system is provided for managing a group buying program. The system includes a deal source and a computing device. The deal source includes customer information associated with a plurality of customers and a plurality of offers associated with a plurality of merchants. The computing device is programmed to select at least one offer for presentation to at least one customer based on the customer information.

In yet another aspect, a computer-readable medium is provided for managing a group buying program. The computer-readable medium includes a computer program embodied thereon. The computer program is executable by a processor and includes at least one code segment that is configured to determine customer preferences associated with a plurality of customers. A plurality of offers associated with a plurality of merchants are received. At least one offer is selected for presentation to at least one customer based on the customer preferences.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a schematic illustration of an exemplary group buying system;

FIG. 2 is a schematic illustration of an exemplary computing device that may be used with the group buying system shown in FIG. 1; and

FIG. 3 is a flowchart of an exemplary method that may be implemented using the computing device shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

The subject matter described herein relates generally to electronic commerce and, more particularly, to methods and systems for use in managing a group buying program. In one embodiment, a group buying offer is selected for presentation to a potential customer based on customer information associated with the potential customer. The customer information may include, for example, customer preferences based on a customer history. In such an embodiment, the customer information and the group buying offer are provided by a common source.

As used herein, an element or step recited in the singular and proceeded with the word “a” or “an” should be understood as not excluding plural elements or steps unless such exclusion is explicitly recited. Furthermore, references to “one embodiment” of the present invention or the “exemplary embodiment” are not intended to be interpreted as excluding the existence of additional embodiments that also incorporate the recited features.

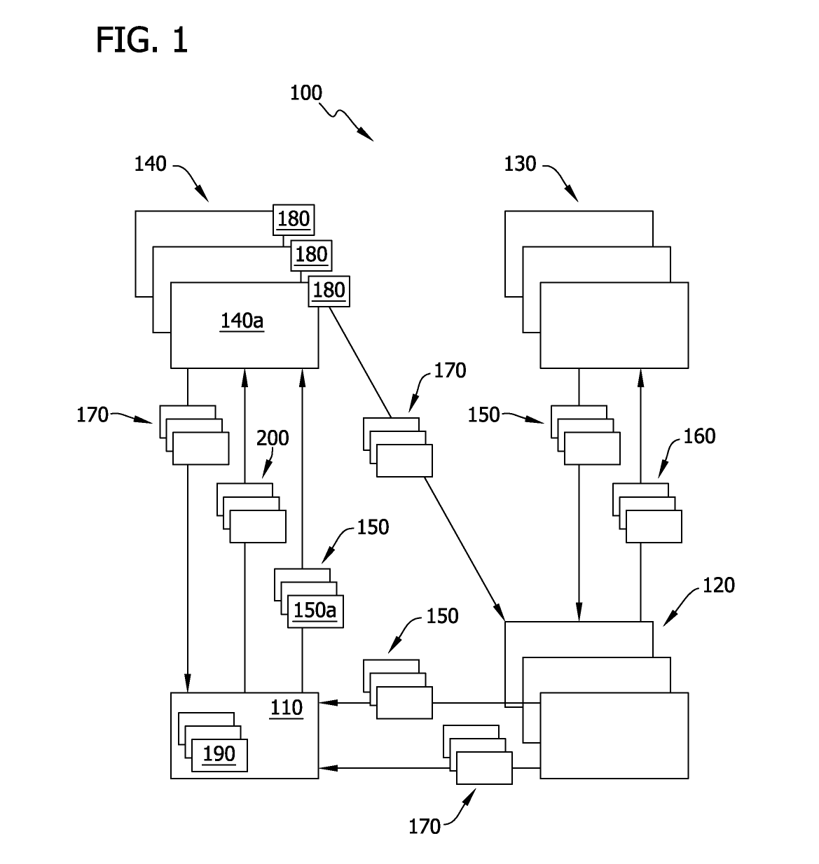

FIG. 1 illustrates an exemplary group buying system 100. In the exemplary embodiment, group buying system 100 includes a manager 110, a plurality of deal sources 120, a plurality of merchants 130, and a plurality of customers or potential customers 140. In the exemplary embodiment, customer 140 purchases, from manager 110, a coupon and/or voucher associated with a good and/or service provided by merchant 130. In the exemplary embodiment, customer 140 presents the voucher to merchant 130 for redemption of the good and/or service, and merchant 130 presents the good and/or provides the service. In the exemplary embodiment, manager 110 distributes the proceeds from the sale of the voucher to deal source 120 and/or merchant 130.

In the exemplary embodiment, deal source 120 is an entity that is separate and discrete from manager 110, merchants 130, and/or potential customers 140. As described in more detail below, in the exemplary embodiment, deal source 120 identifies merchants 130 who are willing to participate in the group buying program, and presents group buying offers associated with merchants 130 to manager 110. As used herein, “group buying offer” refers to a discounted, time-limited offer to provide a good and/or service to a group of potential customers 140. Additionally, in the exemplary embodiment, deal source 120 collects customer data and/or information from potential customers 140, and provides the customer information to manager 110. Alternatively, manager 110 and/or merchants 130 may include at least some of the functions and/or responsibilities of deal source 120.

In the exemplary embodiment, each deal source 120 may be associated with each of a plurality of different geographical markets and/or industries (not shown). Moreover, each deal source 120 may be associated with different merchants 130 located within the respective geographical market and/or operating in the respective industry. Alternatively, group buying system 100 may include any number of deal sources 120 and/or merchants 130 that enables group buying system 100 to function as described herein.

In the exemplary embodiment, deal source 120 receives a plurality of group buying offers 150 from merchants 130. In the exemplary embodiment, deal source 120 is associated with a traditional media company. As used herein, “traditional media” refers to communication means including television, radio, and/or print such as, without limitation, newspapers and magazines. As such, in the exemplary embodiment, deal source 120 may promote and/or advertise group buying offer 150 by providing an advertisement 160 or otherwise mentioning group buying offer 150 through traditional media. In the exemplary embodiment, manager 110 facilitates providing traditional media advertising for merchants 130 by providing and/or presenting deal source 120 with information to prepare and/or market advertisement 160.

In the exemplary embodiment, deal source 120 receives customer information 170 from potential customers 140. More specifically, in the exemplary embodiment, each potential customer 140 is associated with a respective customer interface 180 that receives customer input from the associated potential customer 140. For example, in one embodiment, customer interface 180 includes a set-top box that facilitates collecting customer information 170 including, without limitation, channel input history, channel and/or program viewing history, scheduled recordings, favorite channels and/or programs, and/or search history. Additionally or alternatively, customer interface 180 includes a mobile phone and/or a personal computer. In the exemplary embodiment, each customer interface 180 transmits customer information 170 to deal source 120.

Moreover, in the exemplary embodiment, customer information 170 also includes a geographic location of each potential customer 140 and/or each customer interface 180. For example, in one embodiment, each customer interface 180 may include a geolocation device (not shown) that determines and/or identifies a location of each respective customer interface 180 and that transmits customer information 170 to deal source 120. Alternatively, customer information may be received and/or collected using any mechanism and/or method that enables group buying system 100 to function as described herein.

In the exemplary embodiment, manager 110 receives group buying offers 150 associated with merchants 130 and/or customer information 170 associated with potential customers 140 from deal source 120. Alternatively, manager receives group buying offer 150 and/or customer information 170 from any source that enables group buying system 100 to function as described herein.

In the exemplary embodiment, manager 110 selects at least one group buying offer 150a for presentation to at least one potential customer 140a based on customer information 170 associated with potential customer 140a. More specifically, in the exemplary embodiment, customer preferences 190 are determined based on customer information 170, and group buying offer 150 is selected based on customer preferences 190. Alternatively, any party may determine customer preferences 190 based on customer information 170 that enables group buying system 100 to function as described herein. As used herein, “customer preferences” refers to a class (e.g., category, location, price range) of good and/or service that a customer has an inclination or predisposition to favor. That is, customer preferences 190 are indicative of the customer's taste and/or tendencies, and, as such, a good and/or service that is classified in the customer-preferred class has a higher likelihood of being purchased by the customer than a good and/or service that is not classified in the customer-preferred class.

In the exemplary embodiment, customer information 170 includes group buying offer purchase history. Moreover, to facilitate improving an accuracy and/or precision of determined customer preferences 190, in the exemplary embodiment, manager 110 may receive and/or collect additional customer information 170. For example, manager 110 may periodically present a form to potential customer 140 to collect customer information 170 including, without limitation, age, race, gender, sexual orientation, education, employment, income, marital status, children, religion, and/or political party. Alternatively, manager 110 may receive and/or collect additional information 170 using any mechanism and/or method that enables group buying system 100 to function as described herein.

In the exemplary embodiment, manager 110 presents group buying offer 150a to potential customer 140a through customer interface 180. Additionally, manager 110 may present, promote, and/or advertise group buying offer 150a through new media. As used herein, “new media” refers to communication means including, without limitation, weblogs and/or social media websites. Alternatively, group buying offer 150 may be presented to potential customer 140 using nay mechanism and/or method that enables group buying system 100 to function as described herein.

In the exemplary embodiment, potential customer 140a has an option to participate in group buying offer 150a. If potential customer 140a decides to participate, in the exemplary embodiment, manager 110 presents potential customer 140a with a coupon or voucher 200, and potential customer 140a becomes a customer. In the exemplary embodiment, voucher 200 is transmitted to potential customer 140a electronically via download and/or email. Alternatively, voucher 200 may be delivered to potential customer 140 using any mechanism and/or method that enables group buying system 100 to function as described herein.

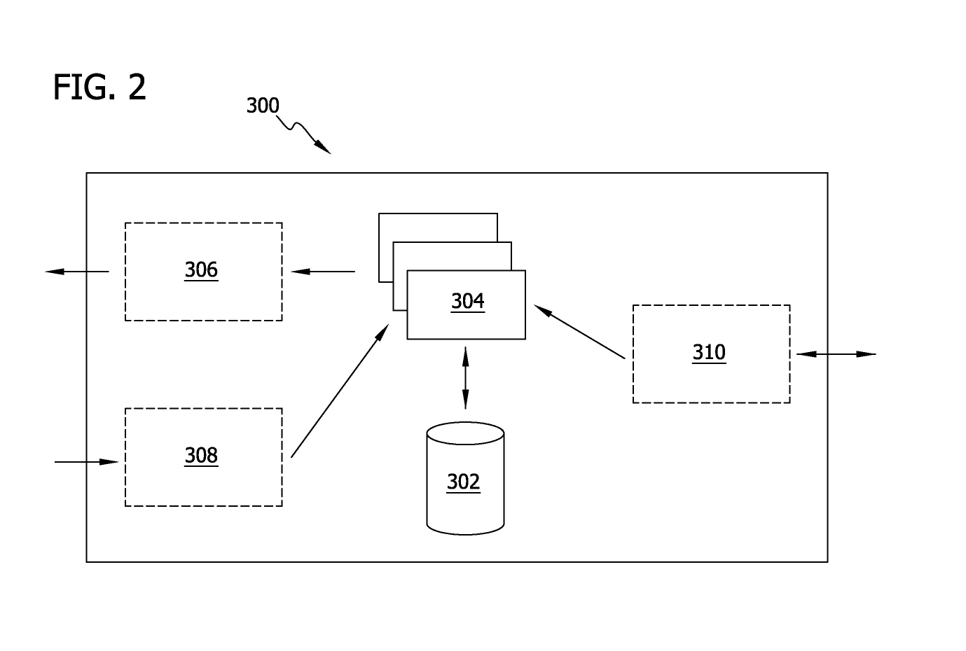

FIG. 2 illustrates an exemplary computing device 300 that may be used by manager 110 to manage group buying system 100. In the exemplary embodiment, computing device 300 includes a memory device 302 and a processor 304 coupled to memory device 302 for use in executing instructions. In the exemplary embodiment, computing device 300 is configurable to perform one or more operations described herein by programming memory device 302 and/or processor 304. For example, processor 304 may be programmed by encoding an operation as one or more executable instructions and by providing the executable instructions in memory device 302.

Processor 304 may include one or more processing units (e.g., in a multi-core configuration). As used herein, the term “processor” is not limited to integrated circuits referred to in the art as a computer, but rather broadly refers to a controller, a microcontroller, a microcomputer, a programmable logic controller (PLC), an application specific integrated circuit, and other programmable circuits.

In the exemplary embodiment, memory device 302 includes one or more devices (not shown) that enable information such as executable instructions and/or other data to be selectively stored and retrieved. In the exemplary embodiment, such data may include, but is not limited to, group buying offers, advertisements, customer information, customer preferences, and/or vouchers. Memory device 302 may also include one or more computer readable media, such as, without limitation, dynamic random access memory (DRAM), static random access memory (SRAM), a solid state disk, and/or a hard disk.

In the exemplary embodiment, computing device 300 includes a presentation interface 306 that is coupled to processor 304 for use in presenting information to a user. For example, presentation interface 306 may include a display adapter (not shown) that may couple to a display device (not shown), such as, without limitation, a cathode ray tube (CRT), a liquid crystal display (LCD), a light-emitting diode (LED) display, an organic LED (OLED) display, an “electronic ink” display, and/or a printer. In some embodiments, presentation interface 306 includes one or more display devices.

Computing device 300, in the exemplary embodiment, includes an input interface 308 for receiving input from the user. For example, in the exemplary embodiment, input interface 308 receives information suitable for use with the methods described herein. Input interface 308 is coupled to processor 304 and may include, for example, a joystick, a keyboard, a pointing device, a mouse, a stylus, a touch sensitive panel (e.g., a touch pad or a touch screen), and/or a position detector. It should be noted that a single component, for example, a touch screen, may function as both presentation interface 306 and as input interface 308.

In the exemplary embodiment, computing device 300 includes a communication interface 310 that is coupled to processor 304. In the exemplary embodiment, communication interface 310 communicates with a remote device (not shown). For example, communication interface 310 may use, without limitation, a wired network adapter, a wireless network adapter, and/or a mobile telecommunications adapter. A network (not shown) used to couple computing device 300 to the remote device may include, without limitation, the Internet, a local area network (LAN), a wide area network (WAN), a wireless LAN (WLAN), a mesh network, and/or a virtual private network (VPN) or other suitable communication means.

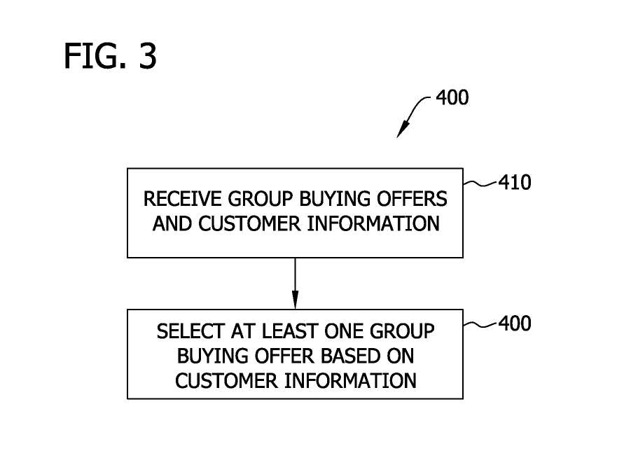

FIG. 3 is a flowchart illustrating an exemplary method 400 that may be implemented by manager 110 to manage group buying system 100. In the exemplary embodiment, group buying offers 150 and customer information 170 are received 410 from deal source 120. More specifically, deal source 120 receives and/or collects group buying offers 150 from merchants 130, and customer information 170 from potential customers 140, and provides group buying offers 150 and customer information 170 to manager 110. In the exemplary embodiment, advertisements 160 may be provided through other traditional media and/or new media to facilitate promoting group buying offers 150.

In the exemplary embodiment, manager 110 selects 430 group buying offer 150a to present to potential customer 140a based on customer information 170 and/or customer preferences 190 associated with potential customer 140a. As such, in the exemplary embodiment, potential customer 140a is specifically targeted for presentation of group buying offer 150a. In the exemplary embodiment, group buying offer 150a may be presented to potential customer 140a through email.

In the exemplary embodiment, group buying offer 150a is automatically selected upon receiving group buying offer 150a from deal source 120. That is, in the exemplary embodiment, group buying offer 150a is received from deal source, and is automatically associated with at least potential customer 140a based on customer information 170 and/or customer preferences 190 associated with potential customer 140a.

In the exemplary embodiment, customer preferences 190 are determined based on customer information 170 including, without limitation, channel input history, channel and/or program viewing history, scheduled recordings, favorite channels and/or programs, search history, geographic location, and/or purchase history. In one embodiment, customer preferences 190 may be stored in memory device 302 in a hierarchical arrangement such that customer preferences 190 have varying weight. That is, in such an embodiment, at least some customer preferences have more or less weight than other customer preferences.

Additionally or alternatively, in the exemplary embodiment, group buying offer 150a may be automatically posted to a weblog and/or social media website and/or presented through television, radio, and/or print. In the exemplary embodiment, group buying offer 150a may be selected for presentation to a group of subscribers and/or the general public based on a predicted degree of interest. In the exemplary embodiment, the degree of interest may be based on, without limitation, a size of discount, a market size, and/or a price. For example, a larger discount may be more appealing to a wider audience than a smaller discount. For another example, a general interest product may be more appealing to a wider audience than a niche interest product. For yet another example, a lower price may be more appealing to a wider audience than a higher price.

The above-described group buying system enables a group buying program to be more efficiently managed and/or widely promoted. More specifically, the above-described group buying system enables targeting potential customers and facilitates increasing awareness of a group buying offers through traditional media and/or new media. As such, the systems and methods described herein facilitate increasing sales and/or revenue associated with the group buying offers.

Exemplary embodiments of systems and methods for managing a group buying program are described above in detail. The systems and methods are not limited to the specific embodiments described herein, but rather, components of systems and/or steps of the method may be utilized independently and separately from other components and/or steps described herein. Each component and each method step may also be used in combination with other components and/or method steps.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of managing a group buying program, said method comprising:
receiving, from a deal source, customer information associated with a plurality of customers and a plurality of offers associated with a plurality of merchants; and
selecting at least one offer from the plurality of offers for presentation to at least one customer of the plurality of customers based on the customer information.

2. A method in accordance with claim 1 further comprising determining customer preferences based on the customer information.

3. A method in accordance with claim 2, wherein selecting at least one offer further comprises automatically selecting the at least one offer based on the customer preferences upon receiving the at least one offer from the deal source.

4. A method in accordance with claim 1, wherein selecting at least one offer further comprises selecting the at least one offer based on a customer location associated with the at least one customer and a deal location associated with the at least one offer.

5. A method in accordance with claim 1 further comprising providing traditional media advertising for at least one merchant of the plurality of merchants.

6. A method in accordance with claim 1 further comprising providing new media advertising for at least one merchant of the plurality of merchants.

7. A system for managing a group buying program, said system comprising:
a deal source comprising customer information associated with a plurality of customers, and a plurality of offers associated with a plurality of merchants; and
a computing device programmed to select at least one offer from the plurality of offers for presentation to at least one customer of the plurality of customers based on the customer information.

8. A system in accordance with claim 7, wherein at least one of said deal source and said computing device is programmed to determine customer preferences based on the customer information.

9. A system in accordance with claim 7, wherein said computing device is further programmed to automatically select the at least one offer based on the customer preferences upon receiving the at least one offer from the deal source.

10. A system in accordance with claim 7 further comprising a customer interface that receives customer input from the at least one customer and transmits customer information based on the customer input to said deal source.

11. A system in accordance with claim 7, wherein said computing device is further programmed to select the at least one offer based on a customer location associated with the at least one customer and a deal location associated with the at least one offer.

12. A system in accordance with claim 11 further comprising a customer interface that includes a geolocation device that is configured to transmit the customer location to said computing device.

13. A system in accordance with claim 7, wherein said computing device facilitates providing traditional media advertising for at least one merchant of the plurality of merchants.

14. A system in accordance with claim 7, wherein said computing device facilitates providing new media advertising for at least one merchant of the plurality of merchants.

15. A computer-readable medium for managing a group buying program, said computer-readable medium comprising a computer program embodied thereon, said computer program executable by a processor and comprising at least one code segment that is configured to:
determine customer preferences associated with a plurality of customers;
receive a plurality of offers associated with a plurality of merchants; and
select at least one offer from the plurality of offers for presentation to at least one customer of the plurality of customers based on the customer preferences.

16. A computer readable medium in accordance with claim 15, wherein the at least one code segment is further configured to automatically select the at least one offer based on the customer preferences upon receiving the at least one offer from the deal source.

17. A computer readable medium in accordance with claim 15, wherein the at least one code segment is further configured to determine the customer preferences based on customer histories associated with the plurality of customers.

18. A computer readable medium in accordance with claim 15, wherein the at least one code segment is further configured to select the at least one offer based on a customer location associated with the at least one customer and a deal location associated with the at least one offer.

19. A computer readable medium in accordance with claim 15, wherein the at least one code segment facilitates providing traditional media advertising for at least one merchant of the plurality of merchants.

20. A computer readable medium in accordance with claim 15, wherein the at least one code segment facilitates providing new media advertising for at least one merchant of the plurality of merchants.
